(19) United States
(12) Patent Application Publication
(10) Pub. No.: US 2025/0233319 A1
(43) Pub. Date: Jul. 17, 2025

(54) ADVANCED THIOL-ENE COMPOSITES THAT UNDERGO RADIOFREQUENCY INDUCED ACTUATION

(71) Applicant: United States of America as Represented by The Secretary of the Army, Alexandria, VA (US)

(72) Inventor: Jared S. Cobb, Clinton, MS (US)

(21) Appl. No.: 18/375,410

(22) Filed: Sep. 29, 2023

(51) Int. Cl. H01Q 17/00; B32B 23/08; B32B 27/20; B32B 27/36

(52) U.S. Cl. CPC H01Q 17/002; B32B 23/08; B32B 27/20; B32B 27/36; B32B 2264/10; B32B 2264/301; B32B 2307/20

(57) ABSTRACT

In one embodiment, a radiofrequency (RF) driven actuator includes: a first layer having a thiol-ene polymer, synthesized to have a formulation represented by PETMPx-EDTy-TMPAEz-TVSa, with subscripts x, y, z, and a referring to nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane (TVS), x+y=100 and z+a=100; a third layer including regenerated cellulose, the third layer having a lower coefficient of thermal expansion (CTE) than the first layer; and a second layer including carbon nanotubes (CNTs) dispersed in a polymer matrix composite. The second layer is a middle layer disposed between the first layer and the third layer to form a composite structure.

### STATEMENT OF GOVERNMENT INTEREST

Under paragraph 1 (a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### CROSS-REFERENCE TO RELATED APPLICATIONS

### Background

### Field of the Invention

The present invention relates to actuating devices and methods and, more specifically, to radiofrequency (RF) induced actuation with improved versatility and efficiency using polymer composites.

### Description of the Related Art

This section introduces aspects that may help facilitate a better understanding of the invention. Accordingly, the statements of this section are to be read in this light and are not to be understood as admissions about what is prior art or what is not prior art.

Actuators play a crucial role in numerous industrial processes, including food and beverage manufacturing and agricultural machinery, where they control the movement of valves, dampers, and other movable objects. Soft robotics is a sub-field that focuses on actuators containing flexible polymers, capable of mimicking human hand movement to handle delicate items.

The problem with traditional soft actuators is that they primarily rely on hydraulic or pneumatic energy sources, necessitating high-pressure pumps and large reservoirs. This makes them impractical for devices with limited space or weight restrictions. Electrically driven soft actuators address some of these issues but still require a wired connection to an energy source, limiting their remote operation capabilities.

### SUMMARY

The present invention was developed to address the desire for more efficient and versatile actuators, particularly in the field of soft robotics. This motivates the development of polymer-based radiofrequency (RF) induced actuators.

The search for new types of actuators that can fit into confined spaces and be activated remotely without a direct connection to a bulky energy source led to the exploration of RF waves as a promising wireless energy transfer method. When combined with carbon-based antennas (e.g., graphene, carbon nanotubes), RF waves have been shown to remotely heat materials for various applications, such as curing epoxy thermosets, welding 3D printed interfaces, and ceramic processing.

Recent advancements in soft actuators utilize RF waves as the energy source to induce bending in a bi-layer polymer composite by creating a differential in the coefficient of thermal expansion. The researchers who developed such soft actuators focused on commercially available polymers, particularly polydimethylsiloxane, and successfully demonstrated control over the bending angle by adjusting the power output of the RF generator. Their work also showed no loss of memory throughout multiple bending cycles. The advancements have limitations, however. The use of commercially available polymers may not provide the optimal thermal properties or flexibility required for specific applications, such as exerting a useful mechanical force on an object. This conclusion is supported by testing that demonstrated the inability of commercially available polymers to exert any useful force onto an object. Furthermore, several of the test actuators caught on fire.

A successful synthesis has been achieved of a novel class of thiol-ene based polymers that incorporate tetravinylsilane to enhance their thermal tolerance and glass transition temperature. This development was confirmed through Fourier Transform Infrared Spectroscopy (FTIR) and differential scanning calorimetry. Additionally, carbon nanotubes were effectively dispersed within the polymer matrix, serving as an RF absorbing layer. From these two newly developed polymers, a tri-layer composite is assembled featuring a relatively lower coefficient of thermal expansion (CTE) backing using regenerated cellulose, a central layer containing carbon nanotubes to absorb radio-frequency waves, and a bottom layer having the novel thiol-ene polymers with a relatively higher CTE to expand upon heating. The frequency for RF wave absorption that produced unexpected results of RF-induced actuation-based lifting in a polymer was determined to be in a frequency range of 143 to 168 MHz and the optimal frequency was 153 MHz. It successfully led to actuation without memory loss between cycles in the various polymer formulations. Furthermore, these actuators were successfully employed to exert force and lift an object, marking the first instance of RF-induced actuation-based lifting in a polymer. The development of these versatile thiol-ene based polymer actuators, with tunable bending angles, response times, and lifting capabilities, has the potential to greatly impact various applications, from soft robotics to adaptive structures, paving the way for innovative solutions in a wide range of fields.

According to an aspect the present invention, a radiofrequency (RF) driven actuator includes: a first layer having a thiol-ene polymer, synthesized to have a formulation represented by PETMPx-EDTy-TMPAEz-TVSa, with subscripts x, y, z, and a referring to nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane (TVS), x+y=100 and z+a=100; a third layer including regenerated cellulose, the third layer having a lower coefficient of thermal expansion (CTE) than the first layer; and a second layer including carbon nanotubes (CNTs) dispersed in a polymer matrix composite. The second layer is a middle layer disposed between the first layer and the third layer to form a composite structure.

In accordance with another aspect of the invention, a radiofrequency (RF) driven actuating method comprises: synthesizing a thiol-ene polymer to form a first layer, the thiol-ene polymer having a formulation represented by PETMPx-EDTy-TMPAEz-TVSa, with subscripts x, y, z, and a referring to nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane (TVS), x+y=100 and z+a=100; dispersing carbon nanotubes (CNTs) in a polymer matrix composite to form a second layer; and covering the second layer with a third layer including regenerated cellulose. The third layer has a lower coefficient of thermal expansion (CTE) than the first layer. The second layer is a middle layer disposed between the first layer and the third layer to form a composite structure.

According to another aspect, a radiofrequency (RF) driven actuator includes: a first layer having a thiol-ene polymer, synthesized to have a formulation represented by PETMPx-EDTy-TMPAEz-TVSa, with subscripts x, y, z, and a referring to nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane (TVS), x+y=100 and z+a=100; a third layer including regenerated cellulose, the third layer having a lower coefficient of thermal expansion (CTE) than the first layer; and a second layer including conjugated carbon dispersed in a polymer matrix composite. The second layer is a middle layer disposed between the first layer and the third layer to form a composite structure.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1A is a schematic view illustrating an example of an assembly of microscope slides used to obtain thiol-ene actuators.

FIG. 1B is a schematic view illustrating an example of carbon nanotube thiol-ene film fabrication.

FIG. 1C shows monomers utilized for thiol-ene film-based actuator fabrication.

FIG. 1D shows a table on a complete list of formulations used in this disclosure with varying mol % of monomers.

FIG. 2 is a schematic view illustrating an example of an actuator assembly.

FIGS. 3A-3D show FTIR results for the thiol-ene polymers after the UV reaction. FIG. 3A shows a peak height indicative of unreacted thiol groups. FIG. 3B shows a peak assumed to be for the reacted Si moiety of the TVS. FIG. 3C shows the theoretical weight percent of TVS in each polymer formulation. FIG. 3D shows the correlation between the peak at 710 cm⁻¹ and the theoretical amount of TVS incorporated into each sample.

FIG. 4A shows graphical plots of transmission versus wavelength for the thiol-ene polymers.

FIG. 4B shows a close-up view of FIG. 4A illustrating the strong prominence of the 710 cm⁻¹ peak in the EDT-TVS sample compared to the PETPM-TMPAE only sample.

FIG. 5A shows glass transition temperatures (Tg) for the thiol-ene polymers; FIG. 5B shows the weight percent of the monomers that contribute to crosslinking; and FIG. 5C shows correlations between the Tg and mass of crosslinking sites demonstrating that the Tg is directly determined by the amount of crosslinking present in the polymer.

FIG. 6 shows a DSC thermogram for one of the thiol-ene polymer samples illustrating one glass transition temperature.

FIG. 7A shows frequency vs temperature sweep from 146 to 154 MHz; FIG. 7B shows frequency vs temperature sweep from 146 to 154 MHZ; FIG. 7C shows PETMP₁₀₀-EDT₀-TMPAE₁₀₀-TVS₀ actuator temperature curve; and FIG. 7D shows PETMP₁₀₀-EDT₀-TMPAE₁₀₀-TVS₀ actuator temperature curve.

FIG. 8 shows a graphical plot of bending angle versus cycles of one of the thiol-ene polymer sample actuators.

FIG. 9A shows bending angle measurements for the polymer actuators; FIG. 9B shows PETMP₁₀₀-EDT₀-TMPAE₁₀₀-TVS₀ based actuator with the overall thickness reduced to 0.15 mm; FIG. 9C shows PETMP₁₀₀-EDT₀-TMPAE₁₀₀-TVS₀ demonstrating controlled bending angle by changing the RF frequency from 145 to 153 MHZ; and FIG. 9D shows PETMP₁₀₀-EDT₀-TMPAE₁₀₀-TVS₀ demonstrating bending as RF at 153 MHz is applied, and after RF is removed from the sample.

FIG. 10A shows the maximum force that the actuator formulations can exert on a glass slide at a bending angle of 0 degrees; FIG. 10B shows PETMP₁₀₀-EDT₀-TMPAE₁₀₀-TVS₀ demonstrating lifting related to the actuator lifting one end of the glass slide; and FIG. 10C shows PETMP₁₀₀-EDT₀-TMPAE₁₀₀-TVS₀ demonstrating lifting related to the actuator bending upward in the middle to lift the same slide.

FIG. 11 shows a table of random forest feature importance rankings for bending angle and the glass transition temperature Tg.

FIG. 12 is a flow diagram illustrating an example of forming an RF-driven actuator having a unique tri-layer composite structure.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

### 1. Introduction

Actuators are crucial components in numerous industrial processes, including food and beverage production and agricultural machinery. They are employed to operate valves, dampers, and other movable objects by converting energy, such as hydraulic, pneumatic, or electrical energy, into physical work. One notable sub-field of actuators is soft robotics, where the actuation devices typically employ flexible polymers that closely mimic the human hand's movement, allowing for the handling of more delicate items. However, these soft robotic devices predominantly rely on hydraulic or pneumatic systems, necessitating high-pressure pumps and large reservoirs. This makes them impractical for applications with limited space or weight constraints. Electrically driven soft actuators address some of these space and weight limitations but still require a direct wired connection to their energy source, limiting their potential as remotely operated actuators. Therefore, there is a need for innovative actuators that can function effectively in confined spaces and be activated remotely without a direct connection to a cumbersome energy source. Such advancements would pave the way for more versatile and efficient actuation solutions in various industries, enabling new applications in remote soft robotic systems. RF waves present a promising solution for wireless energy transfer. When combined with carbon-based antennas, such as graphene or carbon nanotubes, these waves have been demonstrated to remotely heat materials, enabling accelerated curing in epoxy thermosets, rapid welding of 3D-printed interfaces, and more efficient ceramic processing.

Recently, researchers have developed innovative soft actuators that employ RF waves as their energy source. These actuators induce bending through a differential in the coefficient of thermal expansion within a bi-layer polymer composite. When the actuator is heated, the material with a higher coefficient of thermal expansion (CTE) expands more than the material with a lower CTE. This difference in expansion causes stress to build up at the interface of the two materials, leading to bending or deformation. In a bilayer actuator, one layer expands more than the other upon heating, causing the actuator to bend towards the side with the lower CTE. This bending or deformation is what generates the actuation. When the actuator cools down, the materials contract at different rates, causing the actuator to return to its original shape. This reversible behavior enables the actuator to perform cyclic tasks in response to changes in temperature or other external stimuli. Their research focused on commercially available polymers, specifically polydimethylsiloxane (PDMS). They demonstrated the ability to control the bending angle by adjusting the power output of the RF generator, and observed no loss of memory over several bending cycles. These advancements in soft actuators highlight the potential of RF wave-based energy sources for wireless actuation.

Thiol-ene reactions are a type of click chemistry that provides a straightforward approach to creating thermoset polymers without the inherent drawbacks associated with other free-radical initiated polymerizations, such as acrylates and methacrylates. Thiol-ene reactions exhibit several advantageous characteristics, including minimal oxygen inhibition, high reaction conversion, rapid reaction times (less than 10 minutes), low shrinkage, and tunable and precise thermal and mechanical properties. Furthermore, they are known to form nearly ideal networks due to the radical step-growth reaction mechanism. Thiol-ene reactions proceed through the formation of a thiyl radical, which is generated by abstracting the labile hydrogen on the thiol group via an initiator. The thiyl radical then adds across an alkene group (vinyl, allyl, acrylate, methacrylate, etc.) to form a carbon-centered radical, which can then abstract another hydrogen from a thiol to continue the reaction. This process results in the formation of a thioether linkage via an anti-Markovnikov addition of the thiol to an alkene. Owing to their high stereoselectivity and reaction conversion, thiol-ene polymers have been employed in a wide range of applications. These include protein and peptide modification, dendrimer synthesis, nano- and micro-particle production, vibration dampening rubbers, and polymer brushes.

Thiol-ene reactions offer a high level of tunability, which has been leveraged in current research to develop a novel set of thiol-ene-based polymers incorporating TVS. This innovation enhances the thermal and mechanical properties of the base polymer, making it particularly suitable for thermal-induced actuation applications. This study has demonstrated the unique lifting capabilities of an RF-powered polymer actuator.

### 2. Experiments

### 2.1 General Thiol-Ene Film Synthesis

Trimethylolpropane diallyl ether (TMPAE), pentaerythritol tetra(3-mercaptopropionate) (PETMP), ethanedithiol (EDT), and tetravinylsilane (TVS) monomers were mixed in varying ratios along with a photoinitiator (2,2-Dimethoxy-2-phenylacetophenone 99%) and polymerized using a UV free-radical bulk reaction. 1:1 thiol to alkene functional group stoichiometry was maintained for all formulations and chemical composition was altered by changing the ratio of 2-thiol (EDT) to 4-thiol (PETMP) and the ratio of 2-alkene (TMPAE) to 4-alkene (TVS). All chemicals were purchased from Sigma-Aldrich, St. Louis, MO and used as received.

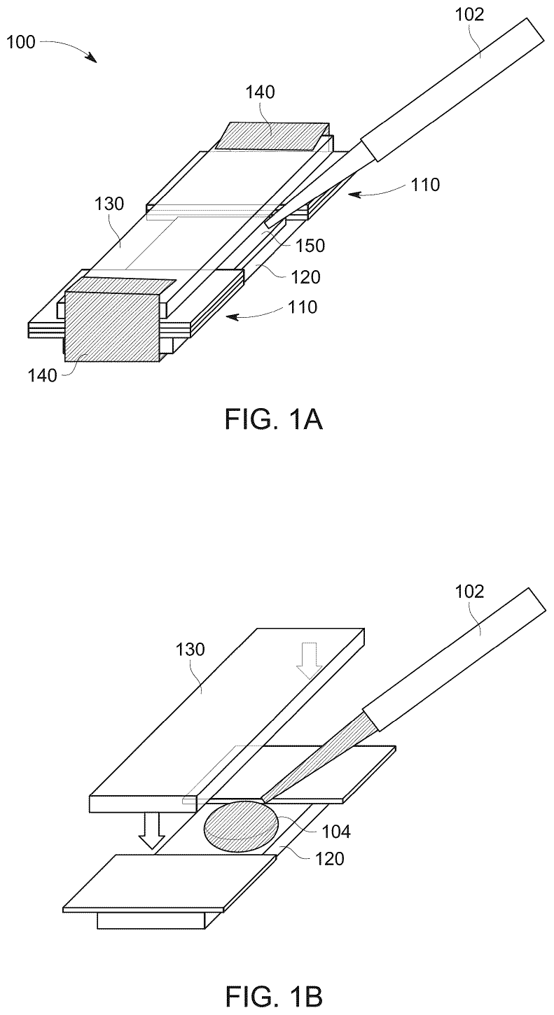

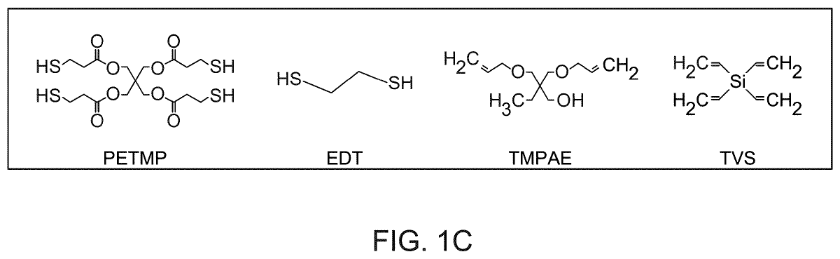

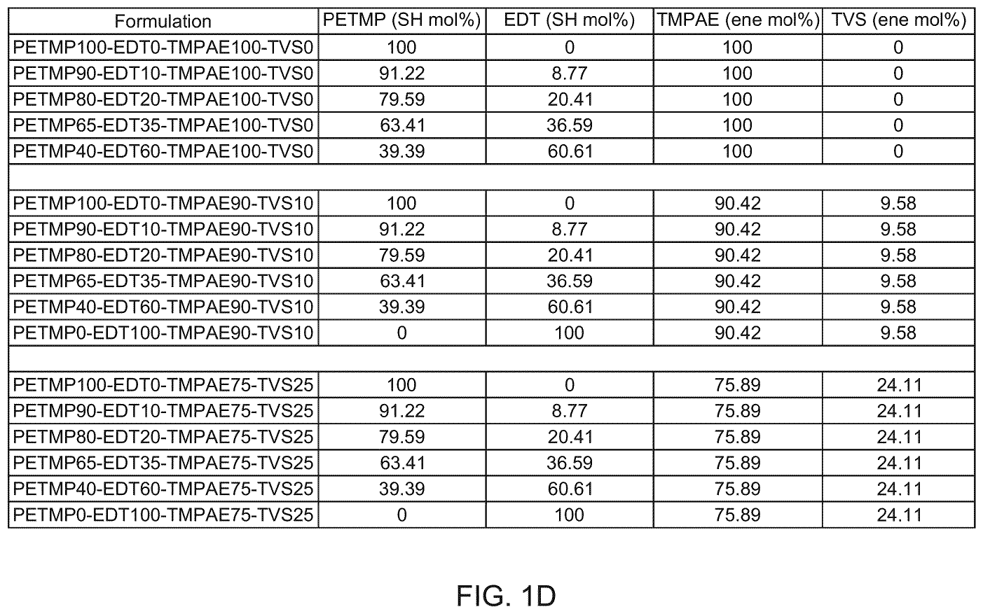

FIG. 1A is a schematic view illustrating an example of an assembly 100 of microscope slides used to obtain thiol-ene actuators. FIG. 1B is a schematic view illustrating an example of carbon nanotube thiol-ene film fabrication. FIG. 1C shows monomers utilized for thiol-ene film-based actuator fabrication. FIG. 1D shows a table on a complete list of formulations used in this disclosure with varying mol % of monomers.

The respective monomers were added to a 10 mL amber vial in the following order to avoid solubility problems arising from TVS's incompatibility with PETMP: (1) TMPAE, (2) TVS, (3) EDT, and (4) PETMP. This order is a critical order that leads to the unexpected results of forming the unique polymer matrix without solubility problems and without any potential phase separation that may result from the addition of TVS. The vial was vortex mixed for 10 seconds after the addition of each monomer to ensure a sufficient mixture of the monomers. 2 wt % of photoinitiator was added to the vial and vortex mixed for 20 seconds and was left to rest on the benchtop for 1 minute to allow any air bubbles in the mixture to escape. Using a pipette 102, the mixture was pipetted into a pre-assembled glass mold 100 made by stacking three 0.15 mm thick microscope cover slips 110 on each side of a standard microscope slide 120 (25×75 mm, Fisherbrand Superfrost, Thermo-Fisher Scientific, Waltham, MA) and placing a second microscope slide 130 on top to form a cavity that was 0.45 mm thick. The nomenclature used to describe the different formulations in this disclosure is PETMPx-EDTy-TMPAEz-TVSa, where the subscripted letters (x, y, z, a) refer to the approximate mol % of the particular monomer in the formulation.

In the example shown in FIG. 1A, two 1-inch binder clips 140 were used to secure the mold 100 together on either end of three microscope slips 110. The monomer-filled mold 100 was placed into a Rayonet photochemical reactor (RPR-100, Southern New-England Ultraviolet Company, Branford, CT) equipped with sixteen 254 nm bulbs (RPR-2537A), for 5 minutes. After polymerization, the mold was removed from the Rayonet chamber, the binder clips 140 were removed, and a razor blade was used to pry the top microscope slide 130 from the mold and subsequently remove the polymer film 150.

A carbon nanotube (CNT) polymer layer is formed by dispersing carbon nanotubes (CNTs) in a polymer matrix composite. In one example, forming the CNT polymer layer includes mixing polymer matrix composite monomers with a polymer matrix composite photoinitiator to form a polymer matrix composite mixture; adding the CNTs to the polymer matrix composite mixture to form a CNT mixture; and polymerizing the CNT mixture using a UV free-radical bulk reaction.

The following describes a carbon nanotube-based thiol-ene layer fabrication as one example of forming the CNT polymer layer. TVS (0.25 mL) was added to EDT (0.246 mL) in a 10 mL transparent glass vial covered with aluminum foil. The mixture was vortexed for 10 seconds. 2 wt % of photoinitiator was added to the vial and vortexed mixed again for 20 seconds and left on the benchtop for 1 minute. The vial was removed from the aluminum foil and allowed to react for 2 minutes 45 seconds at ambient fluorescent light to increase the solution viscosity enough so that when it was shaken, the mixture did not immediately respond to the input. 2 minutes 45 seconds was found to be optimal for dispersing the carbon nanotubes (CNTs) into the monomers. 3 wt % multi-wall carbon-nano tubes (20 nm, cheaptubes.com, Grafton, VT) were added to the vial and vortex mixed for 20 seconds. Films made with 2 wt % CNTs were not conductive for the RF studies, while 4 and 5 wt % CNT's produced films that were too delicate and brittle to be handled. As such, the amount of CNT was greater than 2 wt % and smaller than 4 wt %. The CNT mixture was pipetted onto a microscope slide, one microscope cover slip was placed onto the slide on each side of the solution, and a final microscope slide was placed on top (FIG. 1B). The mold was held in place with 1-inch binder clips as described above. The mold was placed into the Rayonet UV chamber for 10 minutes before removal. The final film thickness was equivalent to the cover slip at 0.15 mm.

### 2.2 Actuator Assembly

The previously synthesized thiol-ene film of interest was placed onto a microscope slide and wetted with a small amount of the PETMP₁₀₀-EDT₀-TMPAE₇₅-TVS₂₅ monomer/photoinitiator mixture as the adhesive. The CNT (carbon nanotube) thiol-ene film was placed onto the wetted film and a second microscope slide was placed on top. Four 1-inch binder clips were used to secure the two microscopes slides together and produce enough pressure to create a sufficiently thin layer of the adhesive between the two films. The assembly was placed into the Rayonet photochemical reactor for 5 minutes before removal. The glued films were then cut into 20×5 mm strips by pushing straight down on them with a razor blade, CNT side up. A regenerated cellulose adhesive tape (Scotch 610, 3M Company, St. Paul, MN) was secured onto the CNT side of the film and trimmed to size. Regenerated cellulose is a class of materials manufactured by the conversion of natural cellulose to a soluble cellulosic derivative and subsequent regeneration, typically forming either a fiber (e.g., rayon) or a film (e.g., cellophane). An example is cellophane with an adhesive backing.

According to one embodiment, an RF driven actuator is a tri-layer composite. “The tri-layer composite is assembled with a lower coefficient of thermal expansion (CTE) backing using regenerated cellulose, a carbon nanotube-containing center polymer for RF absorption, and a higher CTE thiol-ene polymers that expand upon heating.

The first layer or bottom layer includes a higher CTE thiol-ene polymer represented by the formulation PETMPx-EDTy-TMPAEz-TVSa, with subscripts x, y, z, and a referring to approximate nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane as TVS. The subscripts x+y=100 and z+a=100. In some embodiments, the subscript a is less than 30 mol % or less than 25 mol % or less than 24 mol % to avoid solubility issues.

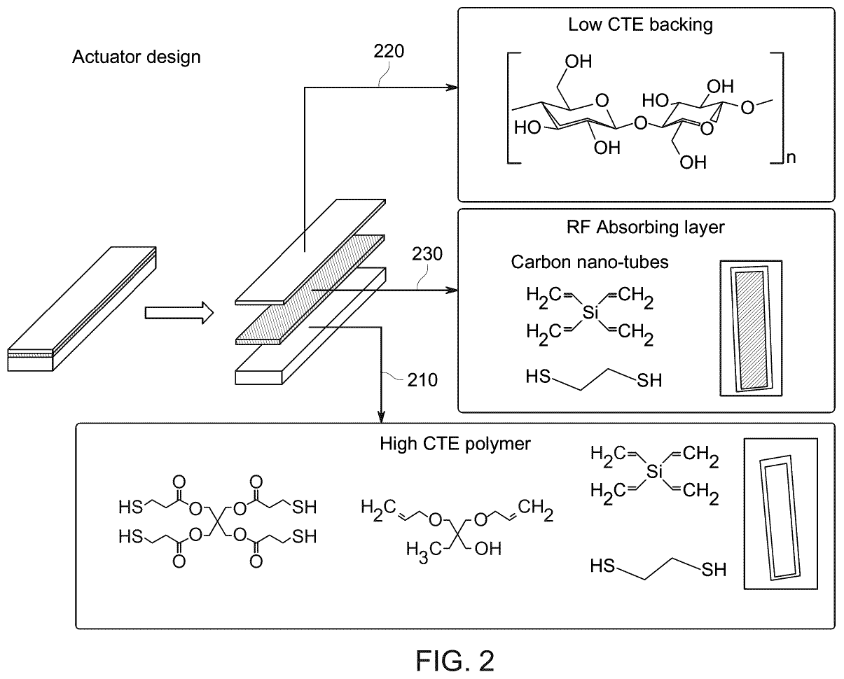

FIG. 2 is a schematic view illustrating an example of an actuator assembly 200. A first layer 210 has a thiol-ene polymer, represented by the formulation PETMPx-EDTy-TMPAEz-TVSa. A third layer 220 includes regenerated cellulose having a lower CTE than the first layer 210. Between the higher CTE polymer first layer 210 and the lower CTE backing third layer 220 is a second layer 230 which is a middle layer 230 that includes CNTs dispersed in a polymer matrix composite. In specific embodiments, the polymer matrix composite in the middle layer 230 comprises a thiol-ene polymer (e.g., PETMP0-EDT100-TMPAE0-TVS100). In alternative embodiments, the middle layer 230 includes conjugated carbon dispersed in a flexible polymer film. The three layers form a composite structure as the actuator assembly 200.

### 2.3 Radiofrequency Induced Actuation

Experiments were carried out using a Rigol DSG815 signal generator and a Prana GN500 signal amplifier. The optimal frequency to induce actuation in each polymer was found by performing a frequency sweep from 1 to 200 MHz and identifying the frequency that heated the sample at the fastest rate and to the highest temperature. A frequency range of 143 to 168 MHz produced unexpected results of RF-induced actuation-based lifting in a polymer, while 153 MHz was found to be optimal for all samples. Power output from the signal generator was held constant at −18 dbm (3 watts at the applicator) and is similar to a cell phone signal in watts. It should be noted that RF waves being put into the atmosphere may have serious consequences for human health at higher power outputs. The samples were placed on an RF applicator consisting of a Teflon™ block with two 5 mm wide copper strips adhered using polyamide tape. The right copper strip was attached to the lead from the signal amplifier that carried the RF signal, while the left strip was attached to a grounded wire. The actuator was held down on the right side by a glass microscope slide so that the bending angle could be measured. Glass slides were used as they do not conduct RF waves, which would interfere with the measurements. Bending angle was calculated using a method that has been previously described. See, e.g., Oh, J. H.; Anas, M.; Barnes, E.; Moores, L. C.; Green, M. J. Site-Specific Selective Bending of Actuators Using Radio Frequency Heating. Adv. Eng. Mater. 2021, 23 (5), 1-9. https://doi.org/10.1002/adem.202000873.

### 2.4 Radiofrequency Induced Lifting

Lifting was performed similarly to the actuation experiments, except a glass slide (2.30 g or 4.60 g) was placed on top of the left side of the actuator. The RF signal was then applied to the actuator, and the bending angle was calculated for each weight. A calibration curve was then generated for each sample to determine how the bending angle changed as a factor of increasing the weight of the glass slide. The maximum force the actuator could exert was calculated by extrapolating the calibration curve to where the bending angle would equal 0 degrees.

### 2.5 Feature Importance

Several models were explored to predict the factors that influenced the bending angle, and glass transition temperature (Tg) of the actuators. A small random forest regressor was found to produce the highest R², and was optimized using 3-fold cross validation and trained in Sci-kit Learn (v. 0.23.1). The final parameters were: bootstrap=False, max_depth=5, max_features=auto, min_samples_leaf=1, n_estimators=10.

### 3. Results and Discussion

### 3.1 Fourier Transform Infrared Spectroscopy (FTIR) Based Characterization of Thiol-Ene Materials

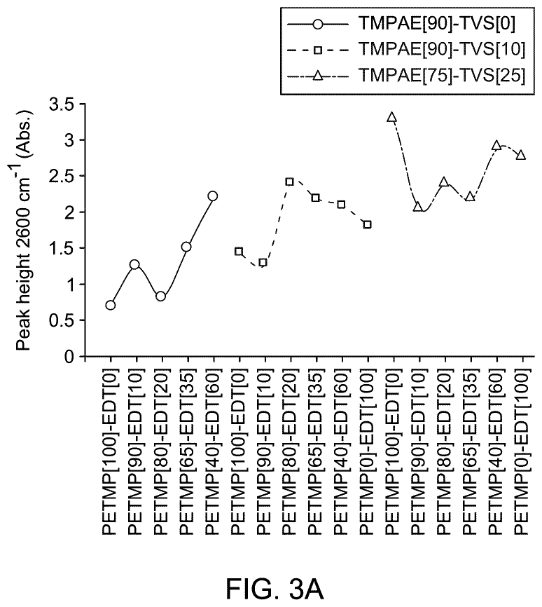

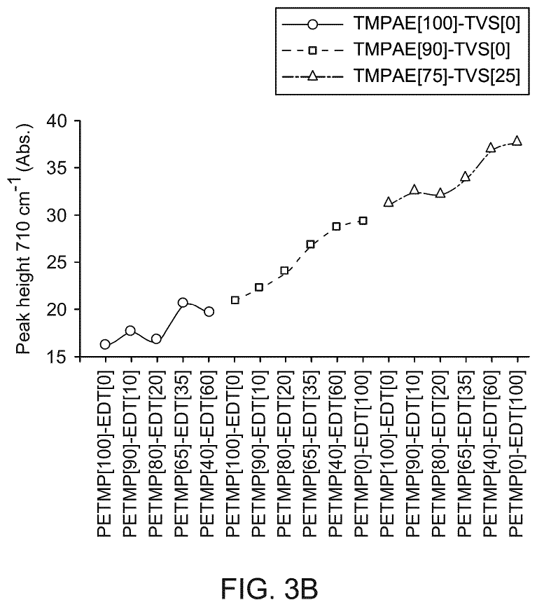

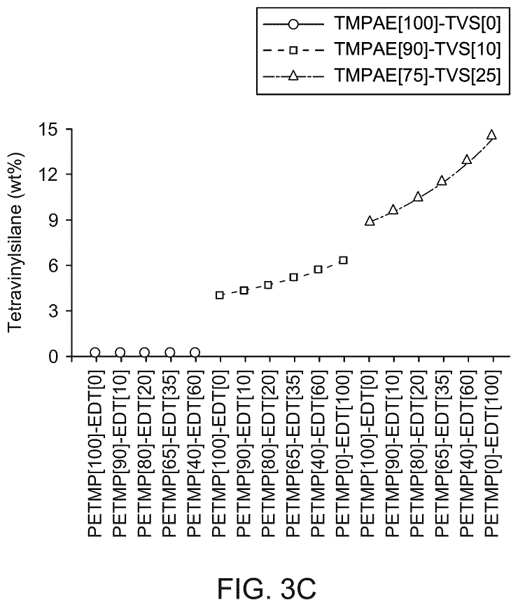

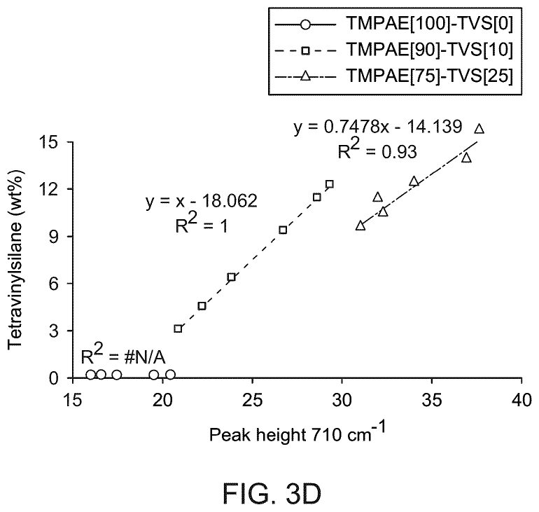

FIGS. 3A-3D show FTIR results for the thiol-ene polymers after the UV reaction. In FIG. 3A, the peak at 2600 cm⁻¹ is indicative of unreacted thiol groups; while the amount of unreacted thiol is very low, the amount increases as the amount of TVS is increased. In FIG. 3B, the peak at 710 cm⁻¹ is assumed to be for the reacted Si moiety of the TVS; as is to be expected, the peak height increases as the amount of TVS is increased. In FIG. 3C, the figure shows the theoretical weight percent of TVS in each polymer formulation. In FIG. 3D, the figure shows the correlation between the peak at 710 cm⁻¹ and the theoretical amount of TVS incorporated into each sample. The excellent correlations demonstrate that the peak at 710 cm⁻¹ is for TVS and that TVS has been successfully integrated into the polymers.

The results from the FTIR analysis of the novel thiol-ene materials revealed that all polymers demonstrated greater than 80% reaction conversion. As the mol % of TVS increased, the reacted thiol decreased in view FIG. 3A. This observation could be attributed to several factors, such as TVS exhibiting low reactivity with PETMP, slowing the reaction, or the vinyl groups of TVS undergoing homopolymerization. The peak at 710 cm⁻¹ is commonly associated with propyl groups, but it can also be attributed to thioether (C—S—C) stretching vibrations. Given the absence of propyl groups in the monomeric structures and the increasing peak height at 710 cm⁻¹ as a function of silane mol %, it is reasonable to assign this peak to thioether vibrations in FIG. 3B. When the mol % of TVS was converted to wt %, the relationship between the amount of TVS and the peak height at the 710 cm⁻¹ vibration band became clearer in FIG. 3C. Linear correlations further confirmed a strong association between the 710 cm⁻¹ peak and the amount of TVS in the samples, indicating that the peak is predominantly due to the presence of TVS. This specificity of the 710 cm 1 peak can be further supported by its strong prominence in the EDT-TVS sample compared to the PETPM-TMPAE only sample.

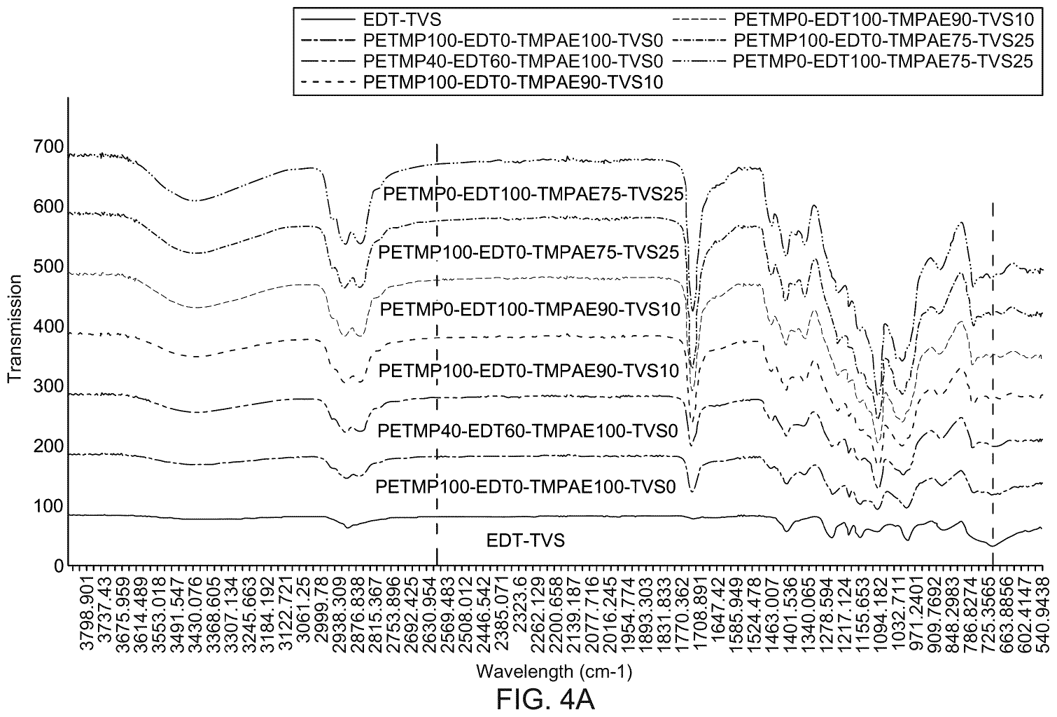

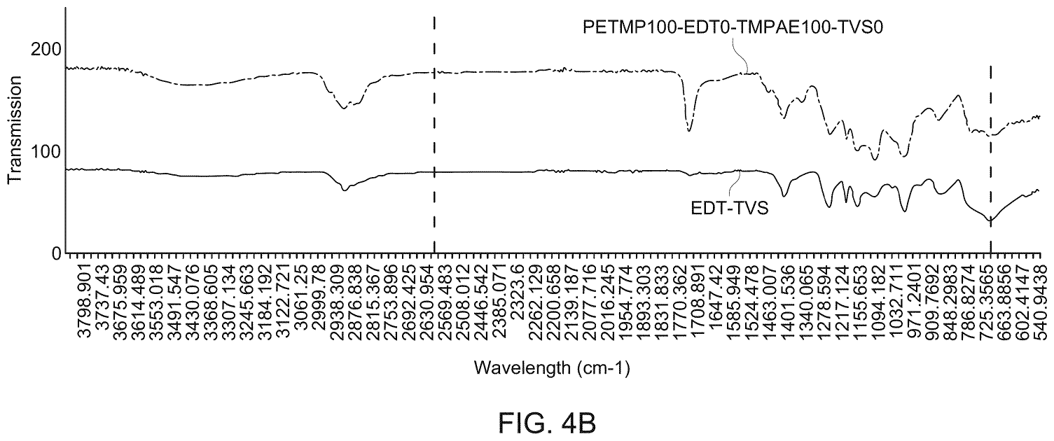

FIG. 4A shows graphical plots of transmission versus wavelength for the thiol-ene polymers. FIG. 4B shows a close-up view of FIG. 4A illustrating the strong prominence of the 710 cm 1 peak in the EDT-TVS sample compared to the PETPM-TMPAE only sample. The reaction of 2,2,4-trimethyl-1,3-pentanediol diisobutyrate (TMPDAE) with PETMP produces a similar thioether peak, but at a higher wavenumber (774 cm⁻¹), due to the additional electronic withdrawing character of the adjacent carbon atoms versus the silicon center of TVS. The specificity of the C—S—C peak for these reactions can be further quantified when EDT is excluded in these polymers, as a new weak peak at 680 cm⁻¹ emerges. This indicates the successful reaction between TVS and PETMP, as the wavenumber of the thioether bond is known to decrease with an increase in aliphatic chain length. These relationships provide evidence for the successful integration of TVS into the polymer, leading to the creation of an innovative thiol-ene based formulation.

### 3.2 Differential Scanning Calorimetry (DSC) Characterization of Thiol-Ene Materials

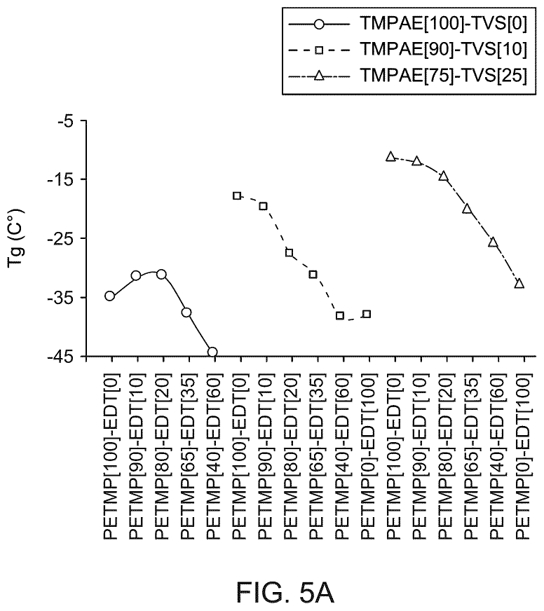

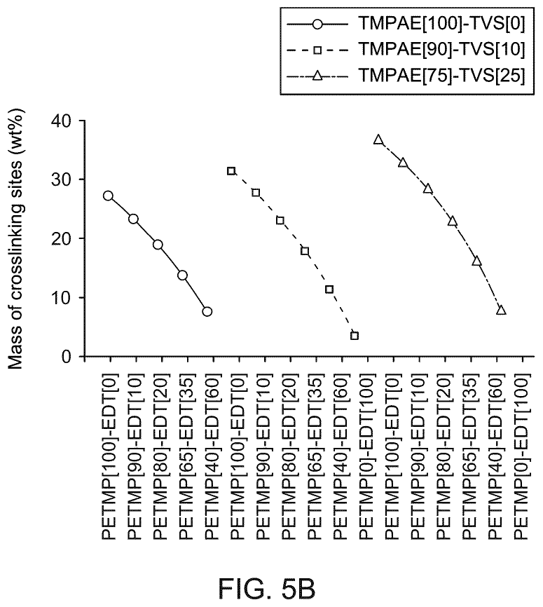

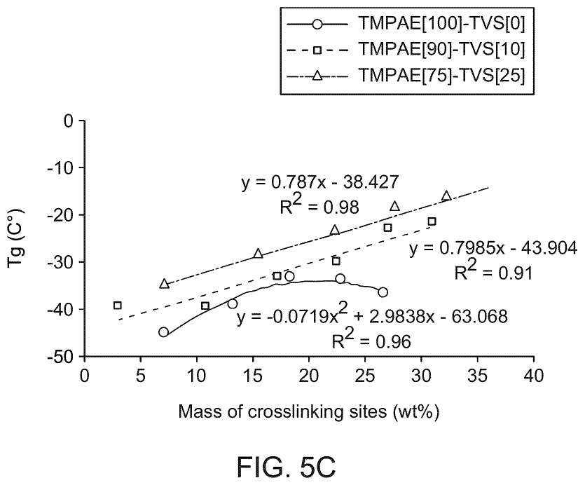

FIG. 5A shows glass transition temperatures (Tg) for the thiol-ene polymers; FIG. 5B shows the weight percent of the monomers that contribute to crosslinking; and FIG. 5C shows correlations between the Tg and mass of crosslinking sites demonstrating that the Tg is directly determined by the amount of crosslinking present in the polymer.

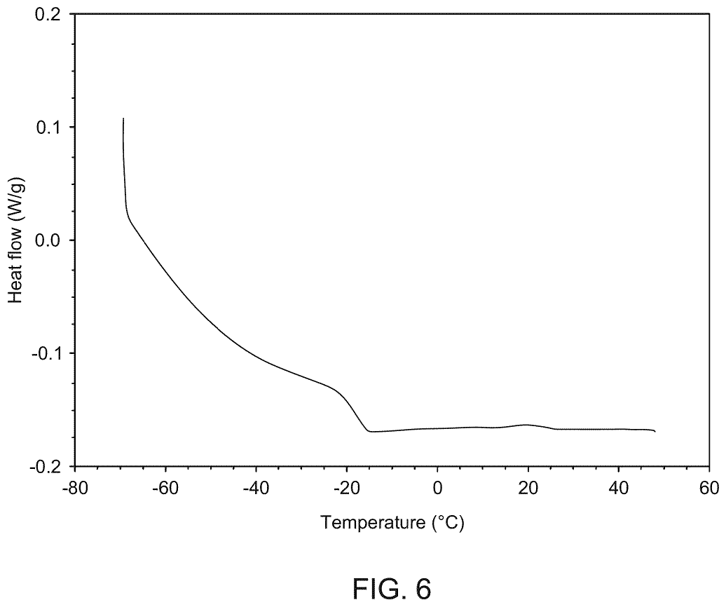

Differential Scanning calorimetry (DSC) was employed to characterize the thermal properties of the polymers, specifically the Tg, and to investigate any potential phase separation resulting from the addition of TVS, as it was initially insoluble in EDT or PETMP monomers. DSC results revealed an almost linear decrease in Tg as the amount of PETMP (4-thiol) decreased for all formulations. Conversely, as the amount of TVS increased, the Tg also increased. This suggests that TVS was successfully incorporated into the polymers and functioned as a crosslinking site in FIG. 5A. The weight percent (wt %) of crosslinking sites within the samples displayed a similar downward trend to the Tg, indicating a direct association between these two properties in FIG. 5B. Correlations were used to establish a relationship between the Tg and mass of crosslinking sites. Strong correlations were established for all three sample groups, suggesting that the wt % of crosslinking sites plays a significant role in determining the Tg of the polymers in FIG. 5C. Variation from linearity appeared in the samples without TVS, which could be attributed to another competing factor. As the amount of PETMP decreased, the crosslinking also decreased. However, the amount of EDT and the space between crosslinks also decreased, which would increase the Tg until the amount of PETMP became too low to maintain efficient crosslinking. The DSC thermograms indicated that there was no phase separation, as only one Tg was observed for all samples. FIG. 6 shows a DSC thermogram for one of the thiol-ene polymer samples illustrating one glass transition temperature. These results are consistent with the FTIR findings, further confirming the successful integration of TVS into the polymer networks.

### 3.3 Radiofrequency Based Actuation Studies on the Thiol-Ene Based Materials

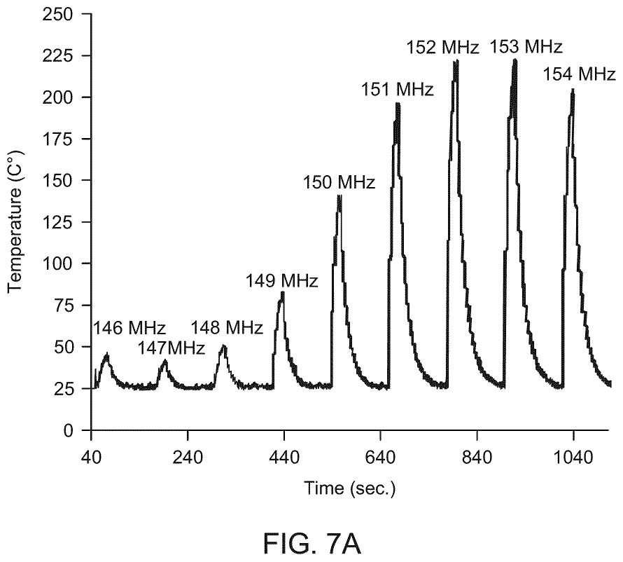

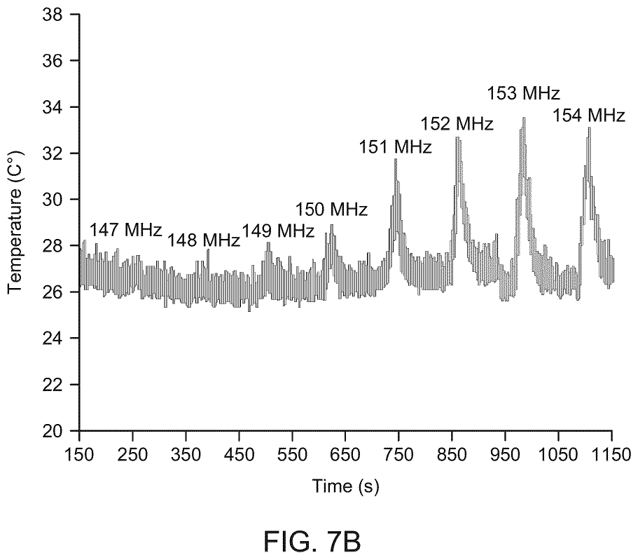

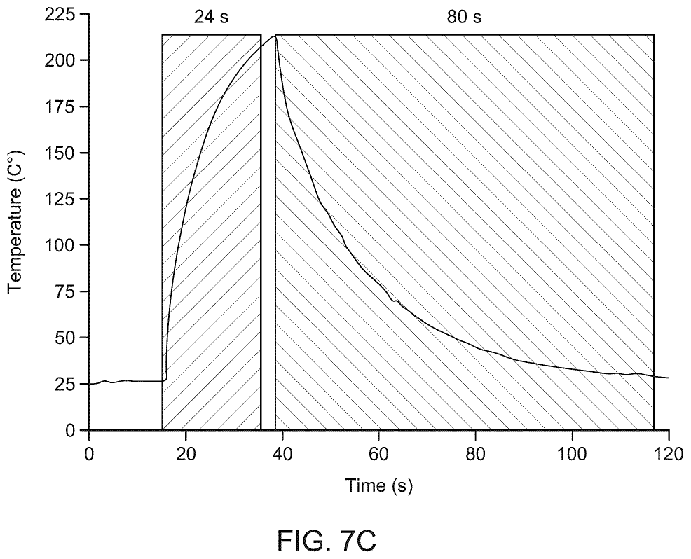

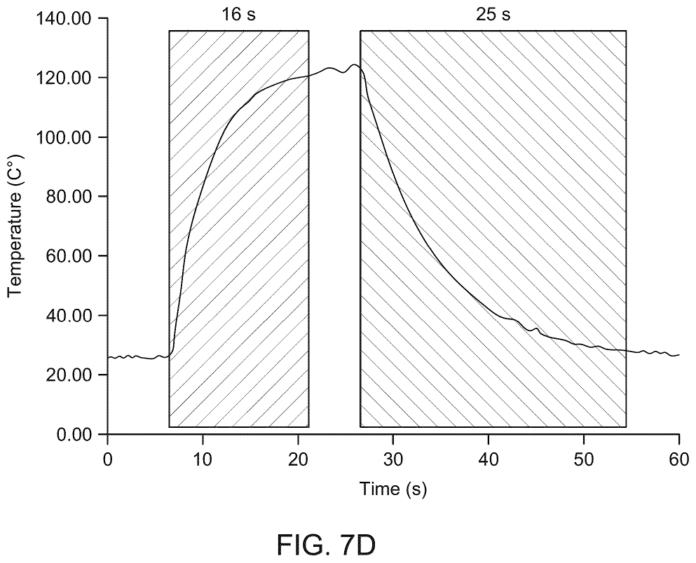

FIG. 7A shows frequency vs temperature sweep from 146 to 154 MHz to find the optimal heating rate frequency to induce actuation; FIG. 7B shows frequency vs temperature sweep from 146 to 154 MHz to demonstrate that the base polymer without CNT's still show a slight temperature increase when RF is applied; FIG. 7C shows PETMP₁₀₀-EDT₀-TMPAE₁₀₀-TVS₀ actuator temperature curve to show how long it took to achieve maximum bending angle for the actuator (left block), as well as the time it took for the actuator to cool back to room temperature and return to the original bending angle (right block); and FIG. 7D shows PETMP₁₀₀-EDT₀-TMPAE₁₀₀-TVS₀ actuator temperature curve to show how long it took to achieve maximum bending angle for the reduced thickness actuator (0.15 mm) (left block), as well as the time it took for the actuator to cool back to room temperature and return to the original bending angle (right block).

The first step in evaluating the actuation capabilities of the thiol-ene-based material was to determine the optimal frequencies for heating the samples. This assessment was initially performed in the range of 50 to 200 MHZ, and the optimal frequency was found to be 153 MHZ for all samples in FIG. 7A. The optimal frequency was chosen based on the highest temperature and the fastest heating rate for all the samples. The base polymers exhibited a minor response to RF waves at the same frequencies found to induce heating in the actuators; however, the magnitude of the heating response was significantly reduced in FIG. 7B. The power output from the signal generator was maintained at 3 W, which is analogous to the signal output of a cellular phone. This power output was selected to minimize the amount of RF waves being emitted into the atmosphere, as higher power outputs could have serious consequences for human health. Previous studies utilizing RF-induced bending have employed between 10 and 125 watts to achieve the temperatures necessary for actuation in their designs. In contrast, the design used in the present study allowed for significantly lower energy outputs to achieve actuation, making it a more efficient and safer alternative. Compared to earlier research in this field, this novel thiol-ene-based material demonstrates enhanced actuation capabilities using a substantially lower power output, while still maintaining optimal performance.

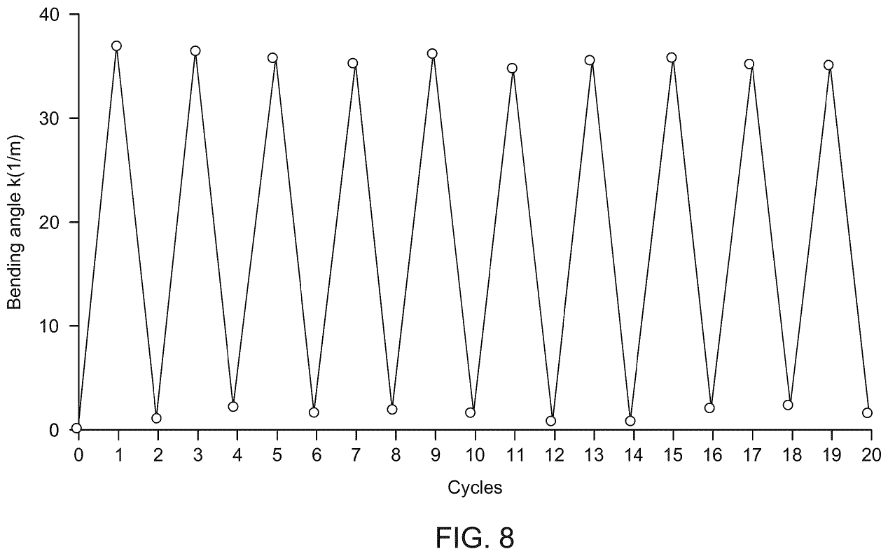

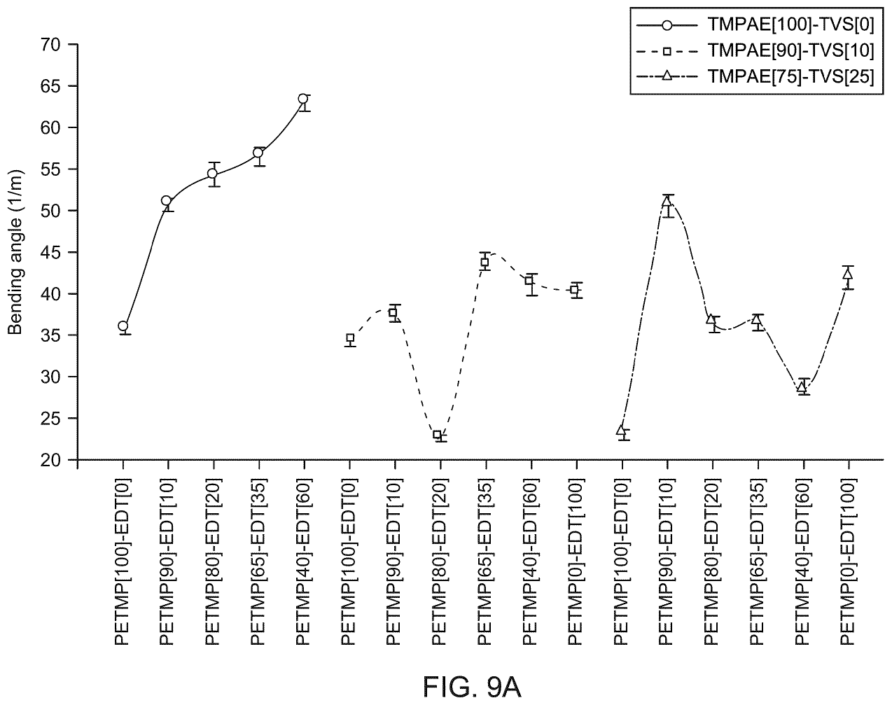

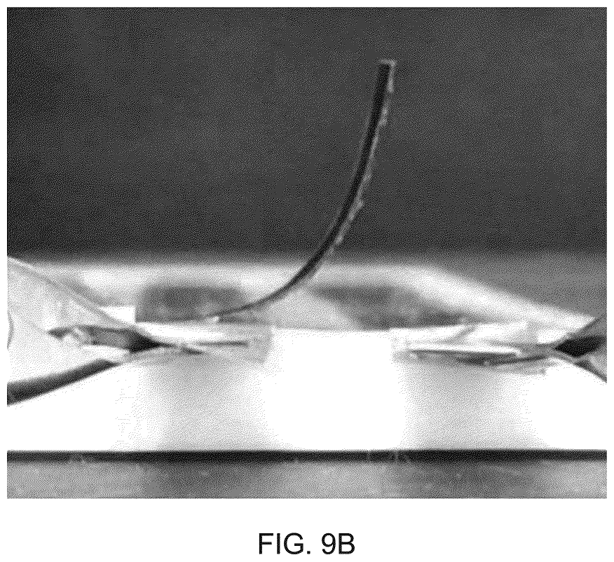

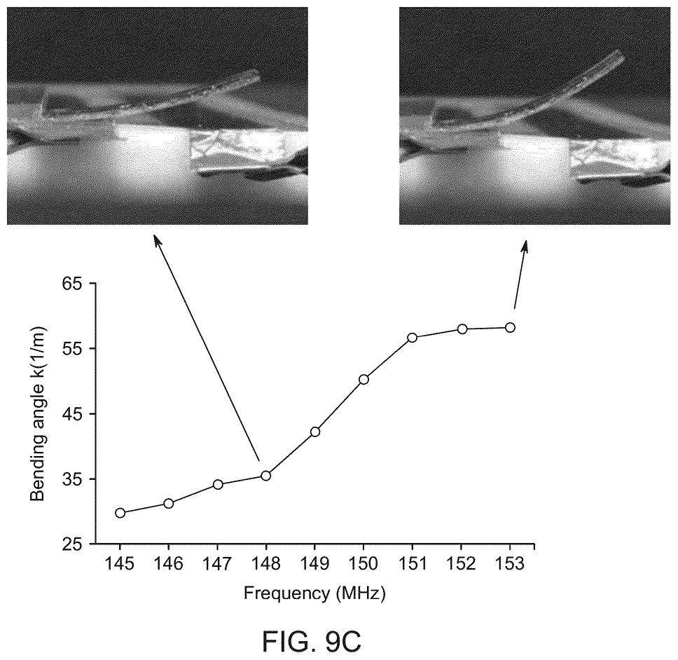

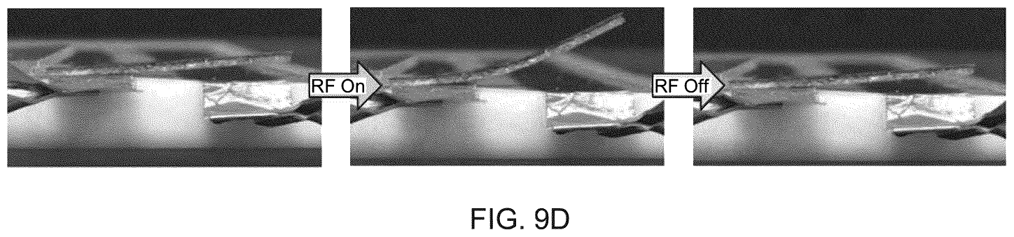

Previous studies have reported no loss of memory after 10 actuation cycles. The actuators for this study demonstrated similar results, with no loss of form observed after 10 cycles. FIG. 8 shows a graphical plot of bending angle versus cycles of one of the thiol-ene polymer sample actuators. Typically, response times for published actuators are around 30 seconds. The novel actuators required less time to reach the maximum bending angle at 24 seconds; however, they also needed a longer recovery time of 80 seconds compared to literature values of around 40 seconds in FIG. 7C. This indicates that these materials can respond quickly to achieve the maximum bending angles, but require a longer recovery time due to a build-up of latent heat within the polymer. This latent heat storage could be attributed to a difference in thickness between these samples and published actuator designs, as these samples are more than three times as thick as other reported RF actuators. To enable a more direct comparison, a sample was constructed with the same layer thickness as published actuators and discovered that the response time was significantly faster than reported values, at around 16 seconds, with a substantially shorter recovery time of 25 seconds in FIG. 7D. Additionally, this thinner sample was able to achieve higher bending angles than the thicker actuators and did not require temperatures as high as the thicker samples to achieve those bending angles, only needing 121° C. (see FIG. 7C and FIG. 9D versus FIG. 9B at a reduced thickness of 0.15 mm)). Compared to previous studies, the novel thiol-ene-based material demonstrates improved actuation performance with faster response times and lower required temperatures, though the thicker samples exhibit longer recovery times. By adjusting the layer thickness, researchers of the present study were able to optimize response and recovery times, further enhancing the material's potential for various applications in the field of soft robotics.

FIG. 9A shows bending angle measurements for the polymer actuators; FIG. 9A shows PETMP₁₀₀-EDT₀-TMPAE₁₀₀-TVS₀ based actuator with the overall thickness reduced to 0.15 mm; FIG. 9C shows PETMP₁₀₀-EDT₀-TMPAE₁₀₀-TVS₀ demonstrates controlled bending angle by changing the RF frequency from 145 to 153 MHz; and FIG. 9D shows PETMP₁₀₀-EDT₀-TMPAE₁₀₀-TVS₀ demonstrating bending as RF at 153 MHz is applied, and after RF is removed from the sample. In FIG. 9A, the samples without TVS (blue) show an almost linear increase in bending angle as the amount of PETMP crosslinker (4-thiol) is reduced. The samples containing 10 mol % TVS (grey) and 25 mol % TVS (orange) show more complicated bending angle patterns that indicate a more complex process is at work.

Bending angle measurements revealed a complex relationship between the polymer formulations, with the exception of the initial samples without TVS, which showed an increase in bending angle as the amount of EDT was increased. The increase in EDT most likely decreased the number of cross-links within the polymer, allowing the polymer to expand more as the actuator was heated in FIG. 9A. This led to higher bending angles than the samples with less EDT and more crosslinking, which would restrict the polymer's expansion. As TVS was incorporated into the samples, interpreting bending angle measurements became more complex due to multiple factors, such as the amount of crosslinking and the spacing between crosslinks in FIG. 9A. FIG. 9C shows the temperature variation within the sample that occurred by systematically increasing the frequency from 146 to 153 MHZ. As the frequency increased, the temperature rose from 50° C. to 230° C. This temperature control could be used to precisely adjust the bending angle of each actuator; as frequency increased, so did the temperature and the bending angle. This enabled precise control over the extent to which the polymer actuators bent in FIG. 9C and FIG. 9D. Compared to previous research, these findings highlight the intricate interplay between polymer formulation, crosslinking, and temperature control for bending angle manipulation. The ability to fine-tune the bending angle by adjusting the frequency and temperature offers promising potential for the development of precise, responsive soft actuators for various applications in the field of soft robotics. For example, soft actuators employing the polymer composite can exert force and lift an object, marking the first instance of RF-induced actuation-based lifting in a polymer. While a frequency of 153 MHz is the optimal frequency that produces the optimal actuator response, a frequency range of 143 to 168 MHz constitutes a critical range that achieves unexpected results of the actuator response.

This study is the first to demonstrate the lifting capabilities of an RF-driven actuator. To measure the force exerted by each actuator on an object, a series of pre-weighed glass slides were used. Glass was chosen because it is opaque to RF waves in the MHz region, unlike metals used in typical force measurement systems. This ensures that the RF waves directly affect the actuator without any interference, providing a more accurate assessment of the actuator's response. One downside of using pre-weighed glass slides instead of a machine to measure force is the potential for reduced accuracy and precision. Machines designed specifically for force measurement typically provide more accurate and consistent results due to their automated and controlled testing environment.

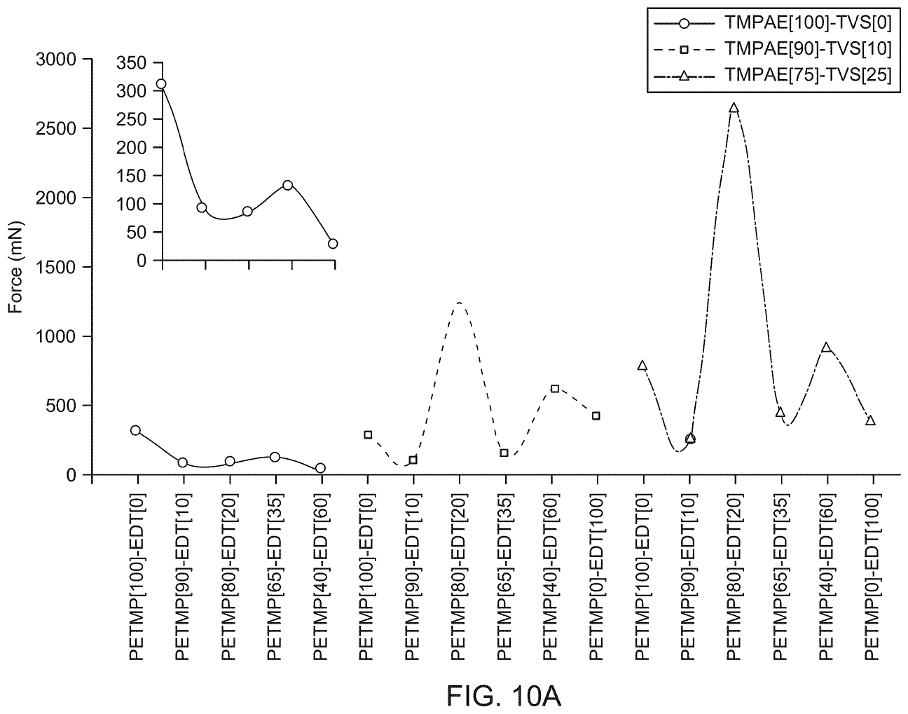

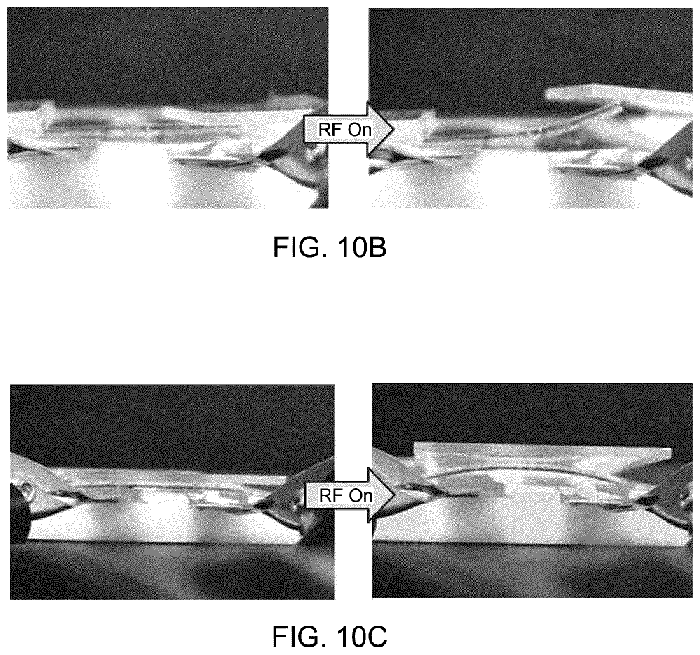

FIG. 10A shows the maximum force that the actuator formulations can exert on a glass slide at a bending angle of 0 degrees; FIG. 10B shows PETMP₁₀₀-EDT₀-TMPAE₁₀₀-TVS₀ demonstrating lifting related to the actuator lifting one end of the glass slide; and FIG. 10C shows PETMP₁₀₀-EDT₀-TMPAE₁₀₀-TVS₀ demonstrating lifting related to the actuator bending upward in the middle to lift the same slide.

It was found that by increasing the amount of EDT and decreasing the amount of crosslinker PETMP, the bending angle increased compared to other formulations (FIG. 9A). This is due to the lower crosslink density imparted by EDT on the polymers, allowing them to flex more easily and likely giving them a higher CTE. Conversely, when force was measured with these actuators, an increase in EDT resulted in a decrease in crosslinking within the polymers and reduced the amount of force they could exert on an object in FIG. 10A. As more TVS was incorporated into the polymers, the crosslink density and the space between crosslinks increased; however, varying the amount of EDT also affected the number of crosslinks, leading to inconsistent results in force measurements for the TVS samples in FIG. 10A. To demonstrate the polymer actuator's ability to lift objects, two orientations were employed: one where the polymer actuator lifted up on one end in FIG. 10B, and the other where the polymer actuator bent in the middle to lift an object in FIG. 10C. Both configurations resulted in the same bending angle and the same amount of force being exerted onto the glass slides. This showcases the overall versatility of these polymer actuators and their potential for use in different bending configurations to exert force on objects as needed. Compared to previous research, the present study highlights the importance of understanding the relationship between polymer formulation, crosslink density, and actuator performance. The ability to tailor these factors to achieve desired bending angles and lifting capabilities is important to the development of responsive and versatile soft actuators.

### 3.4 Relationship Between the Bending Angle and Force Measurements Due RF Based Actuation Process

A random forest was chosen to model the relationships that may define bending angle and glass transition temperatures because it can model non-linear relationships between features and target variables more effectively than linear methods like LDA, which assumes that the data can be separated by a linear decision boundary. Random forests can capture interactions between features without explicitly modelling them, unlike methods such as LDA or logistic regression, which require manual feature engineering to account for interactions. Lastly, random forests provide an intuitive way to estimate feature importance by measuring the impact of each feature on the accuracy of the model. This allows for a straightforward ranking of the features based on their importance, which is not as easily achieved with methods like LDA.

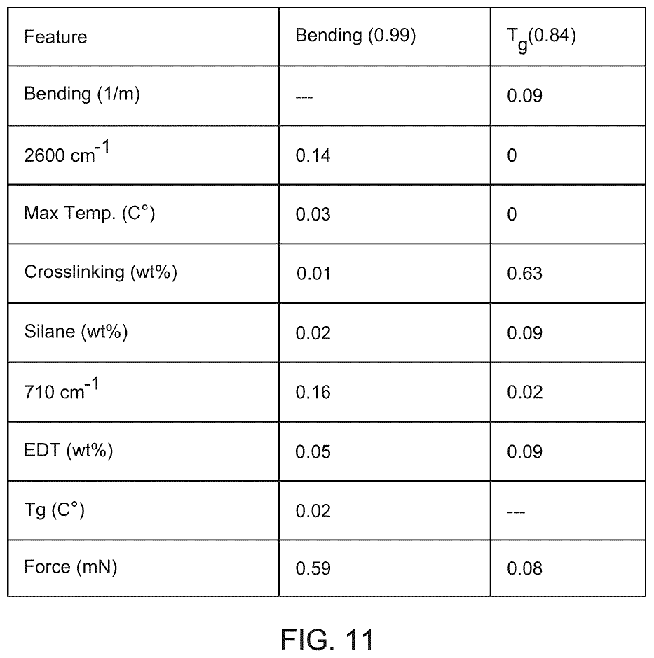

FIG. 11 shows a table of random forest feature importance rankings for bending angle and the glass transition temperature Tg. The random forest analysis confirmed that the amount of crosslinking was the most influential factor in determining Tg. The significance of crosslinking amount on the Tg of a crosslinked polymer is closely related to the polymer's molecular mobility and chain dynamics. In a crosslinked polymer, the chains are interconnected by covalent bonds at crosslinking sites, which restrict the movement of the chains relative to each other. When the amount of crosslinking in a polymer increases, the polymer network becomes more rigid, and the molecular mobility of the polymer chains is reduced. As a result, the Tg, which is the temperature range where a polymer transitions from a glassy, brittle state to a rubbery, more flexible state, is affected. A higher crosslink density typically leads to a higher Tg, as the chains require more thermal energy to overcome the restrictions imposed by the crosslinks and gain sufficient mobility for the glass transition to occur. Consequently, the amount of crosslinking is a crucial factor in determining the Tg of a crosslinked polymer, as it directly influences the polymer's molecular mobility and overall mechanical properties.

The maximum force exerted by the samples was found to be related to the amount of unreacted thiol, the maximum temperature the samples could achieve with RF heating, and the Tg of the base layer. It highlights the complex interplay between these factors and their influence on the performance of the actuators. The amount of unreacted thiol is indicative of the extent of the reaction and crosslinking within the polymer network. A higher concentration of unreacted thiols can lead to a less dense crosslinked network, which in turn can affect the mechanical properties and the force exerted by the actuator. The presence of unreacted thiols can also impact the overall stiffness and elastic modulus of the material, further influencing the actuation force. The maximum temperature the samples could achieve with RF heating is another critical factor, as it determines the extent of thermal expansion and the ability of the polymer to undergo the required phase transitions for actuation. Higher temperatures can result in more significant expansion and greater molecular mobility, leading to increased bending and actuation forces. Lastly, the Tg of the base layer plays a vital role in defining the actuator's behavior. A material with a higher Tg requires more energy to transition from a glassy to a rubbery state, which influences the response time and the force exerted during actuation. A higher Tg can also result in stiffer material properties and potentially impact the actuation force, depending on the material's mechanical properties in the rubbery state. It is noteworthy that the maximum force, being derived from the bending angle measurements, is strongly influenced by the bending angle. As the actuator bends, it generates strain in the material, which in turn creates stress within the polymer network. This stress is responsible for producing the force exerted by the actuator on an object or load. The relationship between bending angle and force is based on the principle that as the bending angle increases, so does the strain in the material. This increased strain results in a higher stress within the polymer network, leading to a greater force exerted by the actuator. Essentially, the bending angle serves as an indicator of the deformation and stress experienced by the material, which ultimately determines the maximum force the actuator can produce. It is important to note that other factors, such as material properties, crosslink density, and actuator dimensions, also play a role in determining the force exerted by the actuator. Nevertheless, the bending angle serves as a key parameter that directly correlates with the force generation capability of the actuator.

### 4. Summary and Conclusion

This study successfully demonstrates the integration of TVS into thiol-ene polymers, as evidenced by the FTIR peak at 710 cm⁻¹ and further confirmed by DSC data, which revealed a single Tg curve indicative of a homogeneous polymer. By incorporating CNTs into the polymer, the tri-layer actuator was effectively fabricated. The actuators displayed a range of bending angles that could be controlled by altering the monomer ratios within the polymer and adjusting the frequency of the applied radio waves. Reducing the thickness of the actuators resulted in increased bending angles and faster response times, but hindered their ability to lift the glass slides. Although the change in EDT introduced some complexity, an overall increase in force exerted by the actuators was observed with a higher TVS content, most likely due to the higher Tg of the polymers. The extent of the bending angle for each polymer was strongly correlated with the amount of reacted thiol and the presence of TVS within the polymer. Moreover, the Tg was found to have a strong correlation with the amount of crosslinking present within the system. These findings highlight the potential of this novel thiol-ene material for diverse applications in the field of responsive polymer actuators. This research not only advances understanding of thiol-ene polymer-based actuators, but also holds great potential for the development of highly responsive, tunable, and versatile materials, paving the way for new applications in soft robotics, biomedical devices, and adaptive structures.

Embodiments of the invention are directed to a novel RF-driven actuator that offers a unique set of features, demonstrating significant advancements in the field of soft robotics. The actuator is designed to operate optimally at a frequency range of 143 to 168 MHz for RF wave absorption that produced unexpected results of RF-induced actuation-based lifting in a polymer. The optimal frequency is 153 MHz.

The optimal frequency and range were determined through extensive testing. This frequency results in the highest temperature and fastest heating rate for all samples, with a power output of 3 W, comparable to the signal output of a cellular phone. In contrast to previous studies that used 10 to 125 watts to induce actuation, the present innovative actuator design requires less power, leading to improved energy efficiency. The response time of the actuators is faster than those reported in the literature, taking only 24 seconds to reach the maximum bending angle. However, the recovery time is longer at 80 seconds, which may be attributed to latent heat buildup within the polymer. The thicker samples in the design could be a contributing factor to this latent heat storage. To facilitate a more direct comparison with published actuator designs, a sample was constructed with the same layer thickness as the existing RF actuators. This sample demonstrated even faster response times of approximately 16 seconds and significantly lower recovery times of 25 seconds. This study is the first to showcase the lifting capabilities of an RF-driven actuator, measuring the force exerted on an object using pre-weighed glass slides. By adjusting the ratio of EDT (a component that affects the crosslink density) and crosslinker PETMP, it is possible to increase the bending angle, allowing for greater flexibility and potentially higher CTE. The unique features of the present RF-driven actuator, such as the optimal operating frequency, reduced power requirements, faster response times, and lifting capabilities, make it a promising advancement in soft robotics. These benefits, combined with the ability to adjust the polymer composition for improved performance, demonstrate the potential for a wide range of applications and further development in the field.

Embodiments of the invention are directed to an RF-driven actuator capable of lifting objects, utilizing a unique tri-layer composite structure. This actuator is based on a novel class of thiol-ene polymers, which are synthesized to incorporate tetra-vinyl silane, enhancing thermal tolerance and glass transition temperature, as confirmed by FTIR and differential scanning calorimetry. A middle layer of the composite consists of (or comprises) carbon nanotubes, effectively dispersed within the polymer, serving as an RF absorbing layer. The tri-layer composite is assembled with a lower CTE backing using regenerated cellulose (e.g., as a top layer), the carbon nanotube-containing center polymer for RF absorption (a middle layer), and a higher CTE thiol-ene polymer that expands upon heating (e.g., as a bottom layer). The actuator is designed to operate optimally at a frequency range of 143 to 168 MHz for RF wave absorption that produced unexpected results of RF-induced actuation-based lifting in a polymer, resulting in successful actuation and no memory loss between cycles across different polymer formulations. The optimal frequency is identified as 153 MHz. For the first time, these RF actuators have been employed to exert force and lift objects.

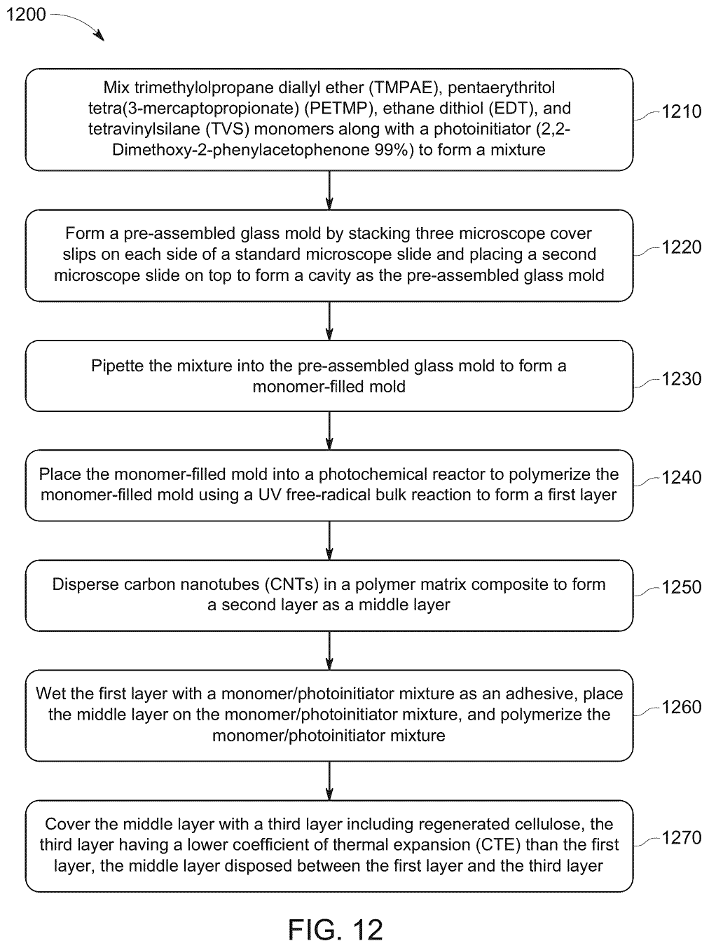

FIG. 12 is a flow diagram illustrating an example of forming an RF-driven actuator having a unique tri-layer composite structure. Step 1210 involves mixing trimethylolpropane diallyl ether (TMPAE), pentaerythritol tetra(3-mercaptopropionate) (PETMP), ethanedithiol (EDT), and tetravinylsilane (TVS) monomers along with a photoinitiator (2,2-Dimethoxy-2-phenylacetophenone 99%) to form a mixture. The order of mixing is (1) TMPAE, (2) TVS, (3) EDT, and (4) PETMP. In step 1220, a pre-assembled glass mold is formed by stacking three microscope cover slips on each side of a standard microscope slide and placing a second microscope slide on top to form a cavity as the pre-assembled glass mold. Step 1230 involves pipetting the mixture into the pre-assembled glass mold to form a monomer-filled mold. In step 1240, the monomer-filled mold is placed into a photochemical reactor to polymerize the monomer-filled mold using a UV free-radical bulk reaction to form a first layer. Steps 1210 to 1240 presents one embodiment of synthesizing a thiol-ene polymer to form the first layer having a formulation represented by PETMPx-EDTy-TMPAEz-TVSa, with subscripts x, y, z, and a referring to nonzero mol % of respective particular monomers in the formulation, including TMPAE, TVS, PETMP, and EDT.

Step 1250 involves dispersing CNTs in a polymer matrix composite to form a second layer which is a middle layer. In a specific embodiment, the middle layer is formed by mixing polymer matrix composite monomers with a polymer matrix composite photoinitiator to form a polymer matrix composite mixture, adding the CNTs to the polymer matrix composite mixture to form a CNT mixture, and polymerizing the CNT mixture using a UV free-radical bulk reaction. Step 1260 involves wetting the first layer with a monomer/photoinitiator mixture as an adhesive, placing the middle layer of polymer matrix composite dispersed with the CNTs on the monomer/photoinitiator mixture as the adhesive, and polymerizing the monomer/photoinitiator mixture by a UV free-radical bulk reaction. Alternatively, in place of steps 1250 and 1260, the second layer may be formed directly on the first layer by mixing polymer matrix composite monomers with a polymer matrix composite photoinitiator to form a polymer matrix composite mixture, adding the CNTs to the polymer matrix composite mixture to form a CNT mixture, placing the CNT mixture on the first layer, and polymerizing the CNT mixture using a UV free-radical bulk reaction. The CNT mixture will self-adhere to the first layer.

In step 1270, the second layer as the middle layer is covered with a third layer including regenerated cellulose. The third layer has a lower CTE than the first layer. The middle layer is disposed between the first layer and the third layer to form a composite structure.

The potential commercial applications of this RF-driven actuator are vast, and its innovative features promise to bring improvements to multiple industries. As technology continues to develop, new applications and opportunities are likely to emerge, further expanding its impact and potential. For instance, the wireless nature of the RF-driven actuator could enable remote operation of devices in hazardous or hard-to-reach environments, such as deep-sea exploration, space missions, or nuclear reactor maintenance. These actuators could be employed in soft robotic grippers to handle delicate or sensitive items, such as food products, electronics, and biological samples, ensuring minimal damage and increased precision during handling processes. The actuator's flexibility and responsiveness make it suitable for applications in medical devices, such as prosthetics, exoskeletons, or surgical instruments, where precise, human-like movement is required. The compact, lightweight design of the actuator could be incorporated into smart fabrics or other wearable devices to provide haptic feedback or assist with mobility. The RF-driven actuator could be used to develop structures capable of changing shape or configuration, such as deployable shelters, adjustable solar panels, or morphing aircraft wings, improving efficiency and adaptability. The actuator's unique features could be applied in the creation of immersive, interactive experiences in virtual reality, augmented reality, or gaming systems, providing responsive and realistic feedback to users. The actuators could be integrated into automated systems for manufacturing, assembly, or packaging processes, enabling more precise control and flexibility in handling various materials or products.

Embodiments of the invention can be manifest in the form of methods and apparatuses for practicing those methods. As compared to traditional soft actuators, the benefits of implementing this technology include promising advancement in soft robotics using RF-driven actuators having optimal operating frequency, reduced power requirements, faster response times, improved lifting capabilities, and a polymer composition that can be adjusted for improved performance.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure.

An interpretation under 35 U.S.C. § 112 (f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A radiofrequency (RF) driven actuator comprising:
a first layer having a thiol-ene polymer, synthesized to have a formulation represented by PETMPx-EDTy-TMPAEz-TVSa, with subscripts x, y, z, and a referring to nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane (TVS), x+y=100 and z+a=100;
a third layer including regenerated cellulose, the third layer having a lower coefficient of thermal expansion (CTE) than the first layer; and
a second layer including carbon nanotubes (CNTs) dispersed in a polymer matrix composite;
the second layer being a middle layer disposed between the first layer and the third layer to form a composite structure.

2. The RF driven actuator of claim 1,
wherein the subscript a is less than 25 mol %.

3. The RF driven actuator of claim 1,
wherein the polymer matrix composite comprises a thiol-ene polymer.

4. The RF driven actuator of claim 1,
wherein the second layer has an amount of CNTs which is greater than 2 wt % and smaller than 4 wt %.

5. The RF driven actuator of claim 1,
wherein the third layer comprises cellophane with an adhesive backing.

6. The RF driven actuator of claim 1,
wherein the monomers in the formulation of the first layer are mixed in the following order: (1) TMPAE, (2) TVS, (3) EDT, and (4) PETMP.

7. A radiofrequency (RF) driven actuating method, comprising:
synthesizing a thiol-ene polymer to form a first layer, the thiol-ene polymer having a formulation represented by PETMPx-EDTy-TMPAEz-TVSa, with subscripts x, y, z, and a referring to nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane (TVS), x+y=100 and z+a=100;
dispersing carbon nanotubes (CNTs) in a polymer matrix composite to form a second layer; and
covering the second layer with a third layer including regenerated cellulose, the third layer having a lower coefficient of thermal expansion (CTE) than the first layer;
the second layer being a middle layer disposed between the first layer and the third layer to form a composite structure.

8. The RF driven actuating method of claim 7, further comprising:
mixing trimethylolpropane diallyl ether (TMPAE), pentaerythritol tetra(3-mercaptopropionate) (PETMP), ethanedithiol (EDT), and tetravinylsilane (TVS) monomers along with a photoinitiator (2,2-Dimethoxy-2-phenylacetophenone 99%) to form a mixture in the following order: (1) TMPAE, (2) TVS, (3) EDT, and (4) PETMP; and
polymerizing the mixture using a UV free-radical bulk reaction to form the first layer.

9. The RF driven actuating method of claim 8, further comprising:
maintaining 1:1 thiol to alkene functional group stoichiometry for the formulation.

10. The RF driven actuating method of claim 8, further comprising:
forming a pre-assembled glass mold by stacking three microscope cover slips on each side of a standard microscope slide and placing a second microscope slide on top to form a cavity as the pre-assembled glass mold;
pipetting the mixture into the pre-assembled glass mold to form a monomer-filled mold; and
placing the monomer-filled mold into a photochemical reactor to polymerize the monomer-filled mold using a UV free-radical bulk reaction.

11. The RF driven actuating method of claim 7, further comprising:
wetting the first layer with a monomer/photoinitiator mixture as an adhesive;
placing the polymer matrix composite dispersed with the CNTs on the monomer/photoinitiator mixture as the adhesive; and
polymerizing the monomer/photoinitiator mixture by a UV free-radical bulk reaction.

12. The RF driven actuating method of claim 7,
wherein the subscript a is less than 25 mol %.

13. The RF driven actuating method of claim 7, wherein dispersing the CNTs in the polymer matrix composite to form the second layer comprises:
mixing polymer matrix composite monomers with a polymer matrix composite photoinitiator to form a polymer matrix composite mixture;
adding the CNTs to the polymer matrix composite mixture to form a CNT mixture; and
polymerizing the CNT mixture using a UV free-radical bulk reaction.

14. The RF driven actuating method of claim 7,
wherein the polymer matrix composite comprises a thiol-ene polymer.

15. The RF driven actuating method of claim 7,
wherein the second layer has an amount of CNTs which is greater than 2 wt % and smaller than 4 wt %.

16. The RF driven actuating method of claim 7, wherein covering the second layer with the third layer comprises:
covering the second layer with a regenerated cellulose adhesive tape.

17. The RF driven actuating method of claim 7, further comprising:
applying RF energy, at an RF frequency of about 143 to about 168 MHz, to the composite structure to cause bending of the composite structure due to a difference of CTE between the first layer and the third layer.

18. The RF driven actuating method of claim 17,
wherein the RF frequency is about 153 MHz.

19. A radiofrequency (RF) driven actuator comprising:
a first layer having a thiol-ene polymer, synthesized to have a formulation represented by PETMPx-EDTy-TMPAEz-TVSa, with subscripts x, y, z, and a referring to nonzero mol % of respective particular monomers in the formulation, including pentaerythritol tetra(3-mercaptopropionate) as PETMP, ethanedithiol as EDT, trimethylolpropane diallyl ether as TMPAE, and tetravinylsilane (TVS), x+y=100 and z+a=100;
a third layer including regenerated cellulose, the third layer having a lower coefficient of thermal expansion (CTE) than the first layer; and
a second layer including conjugated carbon dispersed in a polymer matrix composite;
the second layer being a middle layer disposed between the first layer and the third layer to form a composite structure.

20. The RF driven actuator of claim 19,
wherein the polymer matrix composite comprises a thiol-ene polymer; and
wherein the third layer comprises cellophane with an adhesive backing.
